(19) United States
(12) Patent Application Publication
(10) Pub. No.: US 2002/0079003 A1
(43) Pub. Date: Jun. 27, 2002

(54) Straight through flow cage-type valve

(76) Inventor: Daniel Charles Scampini, Costa Mesa, CA (US)

Correspondence Address: Daniel Charles Scampini, 364 Seville Ln., Costa Mesa, CA, 92627, US

(21) Appl. No.: 09/975,468

(22) Filed: Oct. 9, 2001

Related U.S. Application Data
(60) Provisional application No. 60/237,512, filed on Oct. 4, 2000.

(51) Int. Cl. F16K 11/076

(52) U.S. Cl. 137/625.32

(57) ABSTRACT

A cage-type valve having a straight through flow path designed to utilize a variety of linear and rotary actuated plugs for the control of fluids. From the outside, the valve looks like a plug valve, but on the inside it has a multi-ported cage with a plug moveably positioned about it, so that actuation of its plug controls the flow of fluid through the multiple ports of the cage, controlling the flow of fluid through the valve.

I claim the benefit of the filing date of Provisional Application No. 60/237,512 filed on Oct. 4, 2000.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates in general to valves and in particular to straight through flow multi-ported cage-type valves capable of utilizing a variety of plug and porting configurations for controlling the flow of fluid through them. There are a variety of valves on the market designed for control, on/off, safety, relief, throttling, check, stop-check, regulating and other services. Globe valves, and in particular, cage-type globe valves can use a single body with different plugs, porting configurations, and actuation means to provide all of these functions. Cage-type globe valves are typically used in severe service applications, managing the most critical flow conditions by evenly distributing the flow of fluid about their plugs and seats through a series of multiple radial ports. As the size and pressure class of these valves increase, the valves become quite heavy and expensive. There is considerably more pressure drop through these types of valves while in a fully open position than straight-through flow valves such as ball or plug, since the fluid flowing through them must usually make several sharp 90° turns before exiting. If a smaller, lighter valve could be designed which provided the control and durability of cage-type globe valves with a much more direct straight-through flow path, then a less expensive, compact alternative valve would exist, capable of higher maximum flow rates.

### BRIEF SUMMARY OF THE INVENTION

The Present invention functions in much the same way as cage-type globe valves. Cage-type globe valves position a linearly actuated plug and a multi-ported cylinder (a cage) between their body inlet and outlet. These valve bodies have a flow path which typically travels from their inlet, downward through the body and upward again through the bottom I.D. of their cage. The plug, which is positioned within the cage's I.D. is linearly actuated up and down, opening or closing the multiple radial ports of the cage to control the flow of fluid traveling radially out through these ports to an outer area surrounding the cage, where it again travels downward through the body, and then to the body outlet. Flow through the body can travel in either direction. The present invention is similar to cage-type globe valves in that it also positions a multi-ported cage between its body inlet and outlet. However, its flow path through the valve body travels in a much more direct path from the valve body's inlet, straight through a side inlet port of the cage into its I.D. The flow path then continues out through multiple radial ports of its cage to an outer area surrounding them, and then straight to the valve body's outlet. Flow through this valve can also travel in either direction and is controlled by a plug positioned at the I.D. of the cage so that by its actuation, whether linear, rotary or a combination of both, the multiple ports of the cage are opened or closed. The advantage of the present invention over cage-type globe valves is that fluid flow traveling through the present invention does so along a much smoother straighter path, increasing its Cv and reducing its required size and weight. This can reduce purchase, installation, and operating costs for the user. It is all of these features which make the present invention different from all other valves and which gives it the advantages stated.

### BRIEF DESCRIPTION OF THE SEVERAL VIEWS OF THE DRAWING

FIG. 1 is a perspective outside view of the present invention.

FIG. 2 is a perspective sectional view of the body of one embodiment of the present invention showing its cage.

FIG. 3 is the view of FIG. 2 showing the cage further sectioned, revealing its inlet port.

FIG. 4 is a top view of the body showing the flow path through it.

FIG. 5 is a perspective view of one type of plug used with the cage design of FIG. 2.

FIG. 6 is the view of FIG. 2 with the plug of FIG. 5 inserted within its cage.

FIG. 7 is a perspective sectional view of one body cover embodiment of the present invention.

FIG. 8 is a top view of the body and plug of FIG. 6 in a closed position.

FIG. 9 is the view of FIG. 8 in an open position showing the flow of fluid through it.

FIG. 10 is a perspective sectional view and a top view of the body of a second embodiment of the present invention showing its cage offset within the body to its inlet side.

FIG. 11 is a perspective view illustrating the mating portions of a cover, a removable cage, and body modeled after the embodiment of FIG. 10.

FIG. 12 is a perspective view of the components of FIG. 11 showing the cage inserted within the body.

FIG. 13 is a perspective view of a third embodiment of the present invention showing the inlet port of its plug and the seat of its offset cage.

FIG. 14 is a perspective view of the plug inserted within the cage and body of FIG. 13.

FIG. 15 is a top view of the embodiment of FIG. 14 showing the plug in a closed position.

FIG. 16 is the view of FIG. 15 with the plug opening the inlet port to the cage showing the fluid entering.

FIG. 17 is the view of FIG. 15 with the plug in a fully opened position showing the flow of fluid through it

FIG. 18 is a top view of an embodiment the same as that of FIG. 14, but having an eccentric seat and plug, showing the plug in a closed position as in FIG. 15.

FIG. 19 is the view of FIG. 18 with the plug opening the inlet port to the cage showing the fluid entering.

FIG. 20 is the view of FIG. 18 with the plug in a fully opened position showing the flow of fluid through it.

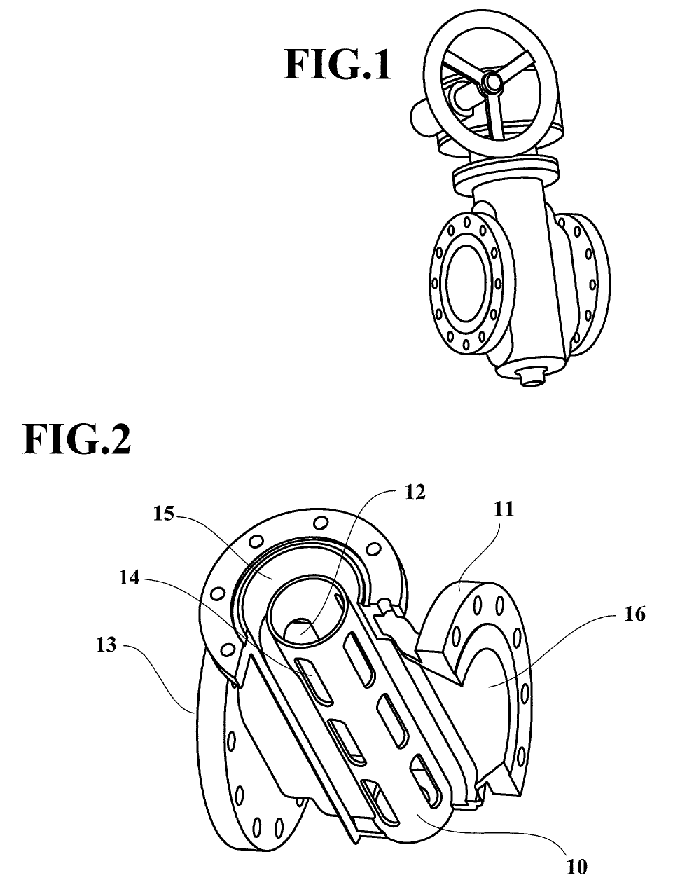

### DETAILED DESCRIPTION OF THE INVENTION

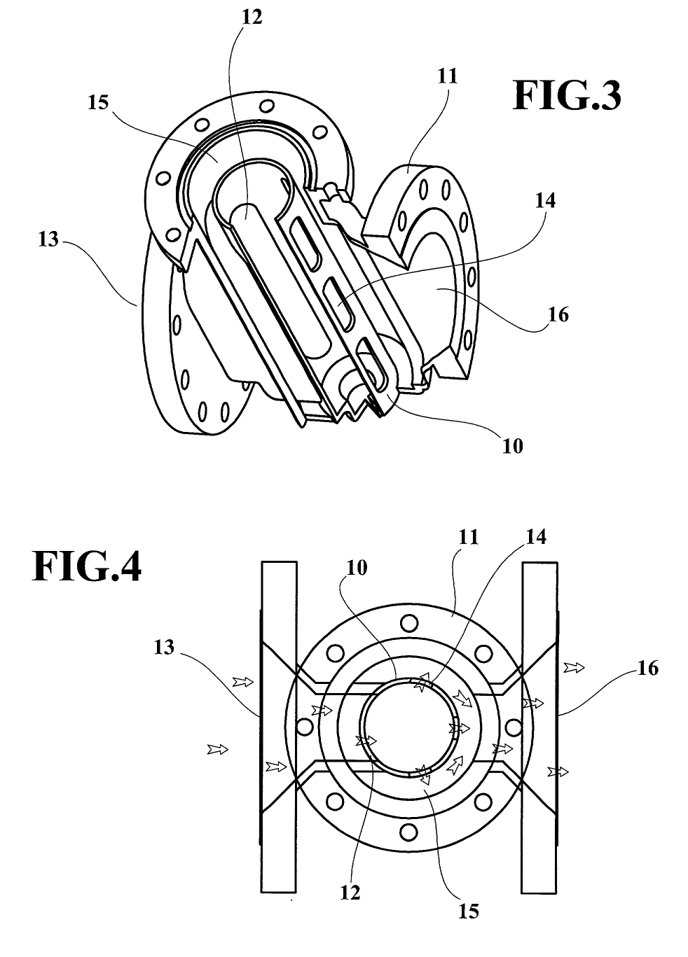

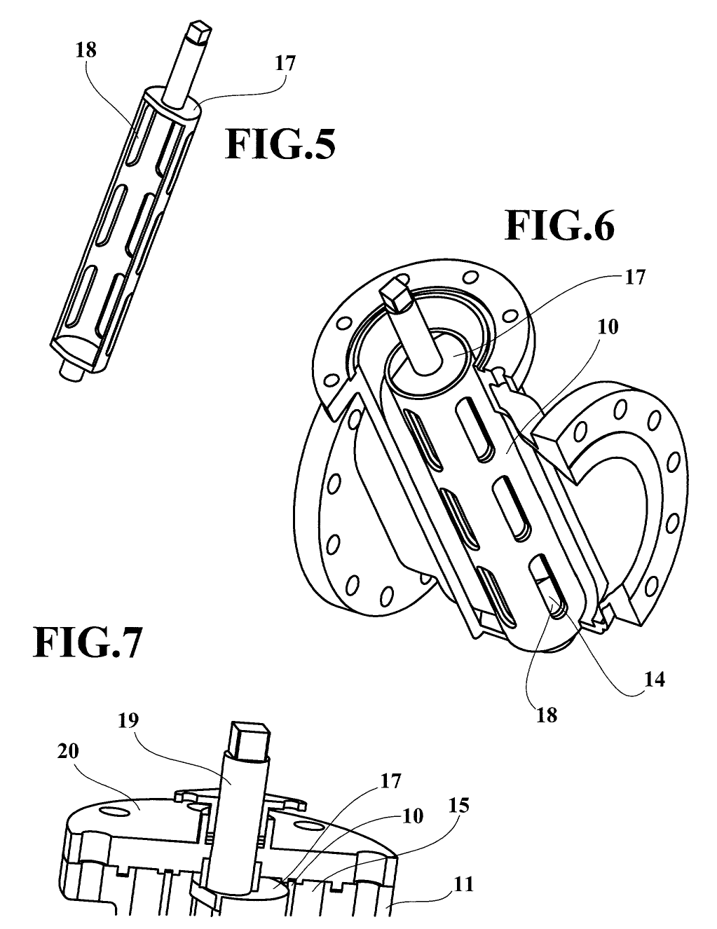

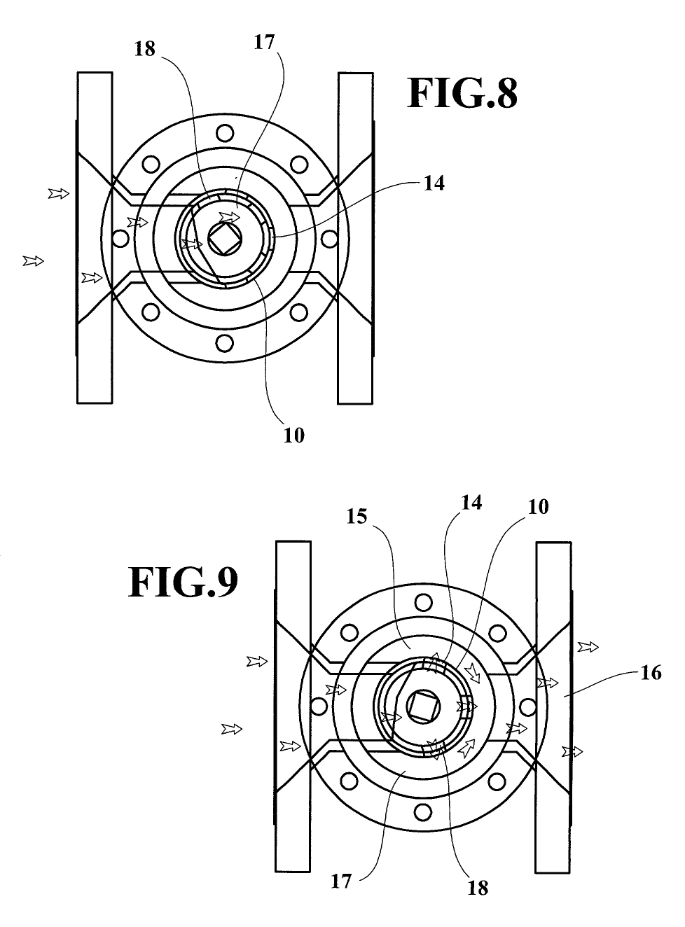

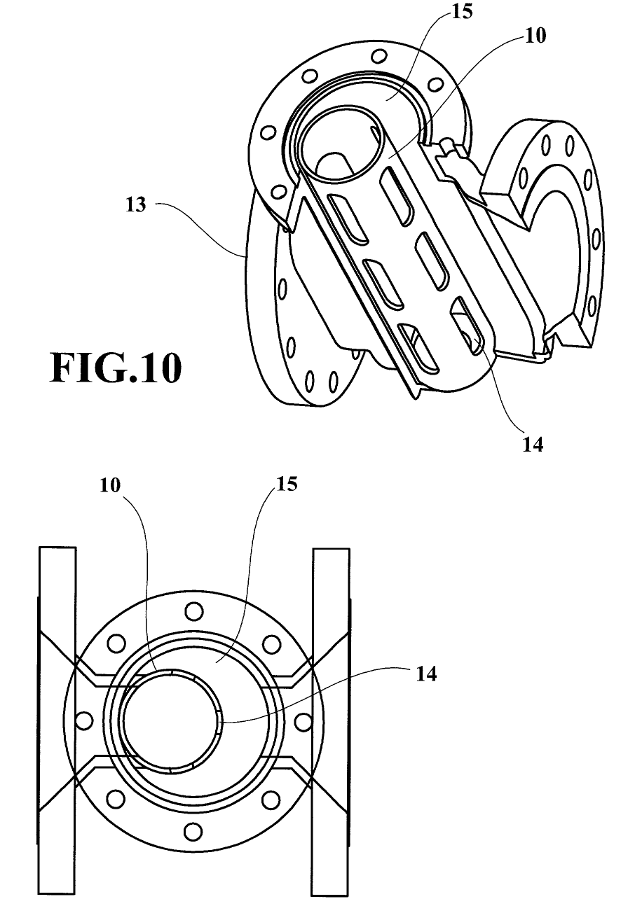

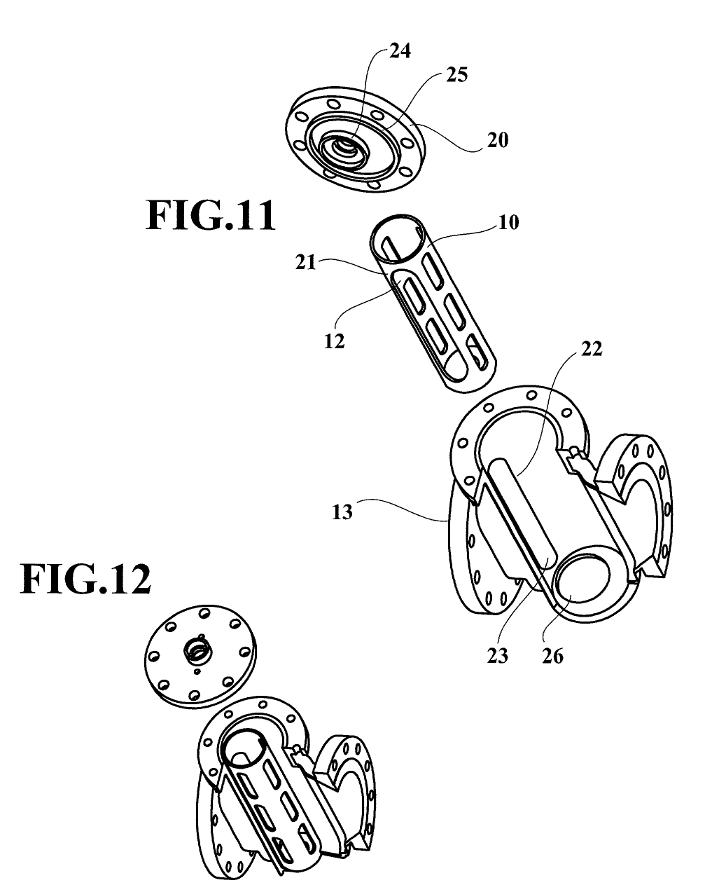

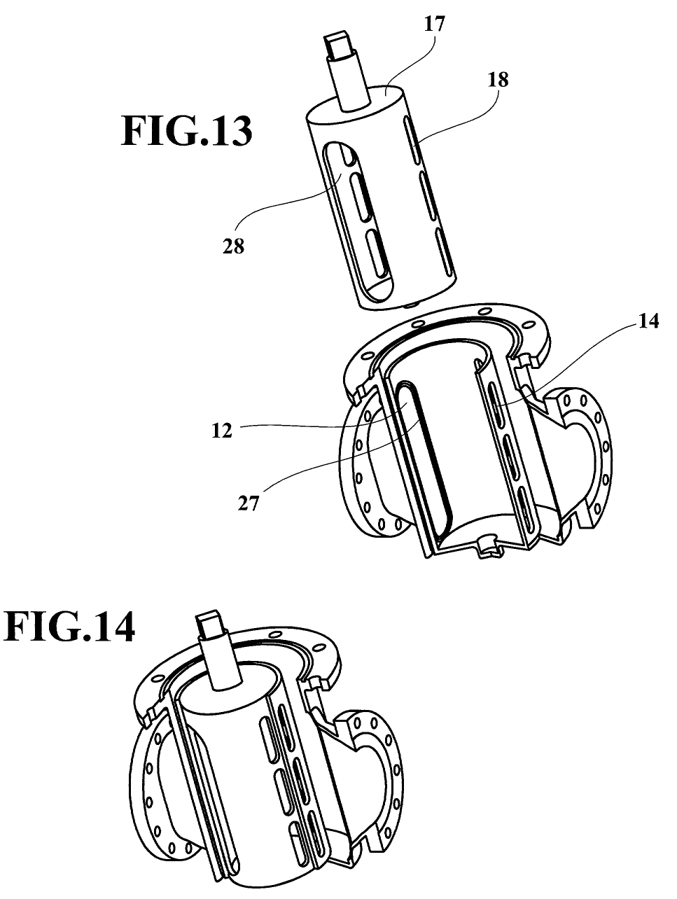

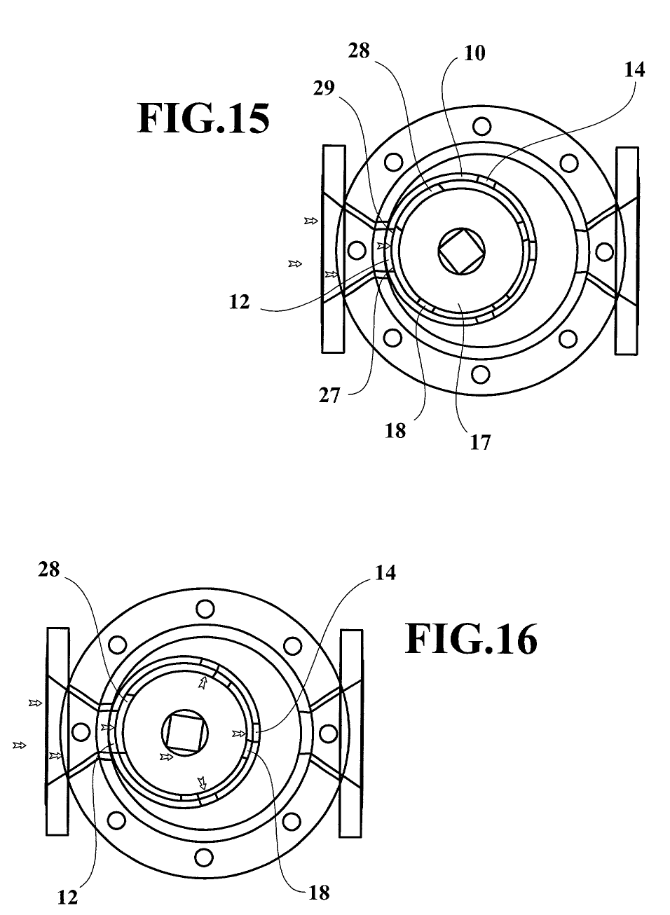

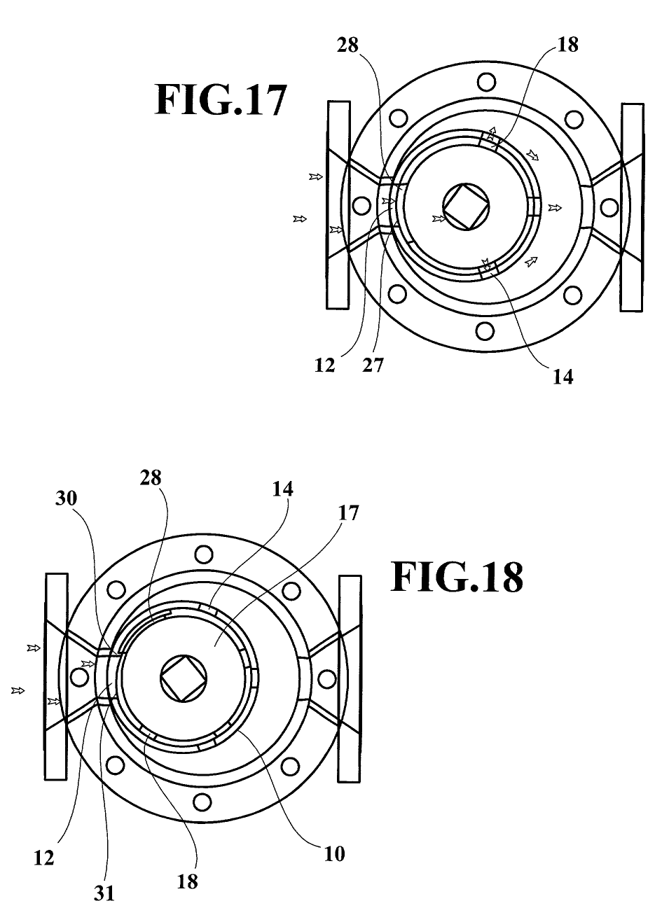

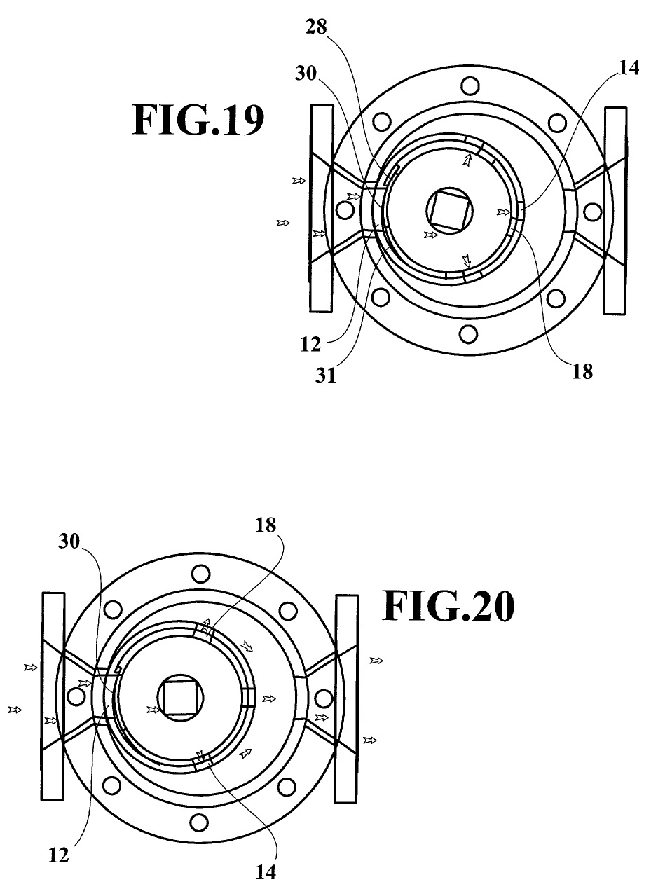

Referring to the embodiment of FIGS. 2-4, the present invention has a multi-ported cage 10 positioned at the center of a valve body 11, connected by its inlet port 12 to the inlet 13 of the valve. The top of the cage is open while its base is closed. The valve body 11 has a direct flow path which begins at its inlet 13 and travels through to the I.D. of the cage 10 via its inlet port 12. The path continues from the cage 10, radially outward through its multiple ports 14 into an outer chamber 15 surrounding the cage, where it then exits the body's outlet 16. Like many plug valves, the flow contour through the body begins round at its inlet 13 and gradually transitions to an oblong shape at the inlet port 12 of the cage. Once through the cage and outer chamber it transitions back from an oblong shape to a round contour at its outlet 16. The cutaway of the cage in FIG. 3 shows a view of its inlet port 12. The top view of the valve body in FIG. 4 shows its flow path from the inlet 13, through the inlet port 12 of the cage 10 to its I.D., radially out through the cage's multiple ports 14 to the outer chamber 15, and then to its outlet 16. Referring to FIGS. 5-9, the present invention has a rotating plug 17 consisting of a cylindrical segment, fully open on one side, with multiple radial ports 18 on the other, matching those of the cage 10. Referring to FIG. 6, the rotating plug 17 is slidably positioned within the cage 10 of the body so that the radial ports of each 14 & 18 are aligned. The plug rotates within the cage to open or close the cage's ports, regulating the flow of fluid through them. The sliding mating surfaces between the plug 17 and cage 10 can be metal to metal, plastic to plastic, ceramic to ceramic etc., or a sleeve of PTFE, graphite, elastomer, ceramic, or other sealing material can be provided between them for better sealing and lubricity. Referring to FIG. 7, the present invention can use conventional rotary sealing of the stem 19 of the plug 17. Its cover 20 seals not only against the body 11, but against the top of the cage 10 to prevent fluid from passing here from within the cage to the outer chamber 15. The present invention may utilize a variety of bonnet, cover, or top sealing means including pressure seal, bolted bonnet or cover plate, threaded, clamped, interlocking and welded designs. Referring to FIG. 8 showing a top view of the plug 17 positioned within the cage 10, when the present invention is in a closed position, the radial ports 18 of the plug are rotatably out of alignment with those of the cage's ports 14. Referring to FIG. 9, in an open position the plug 17 is rotated CW so that its radial ports 18 are aligned with those ports 14 of the cage, allowing fluid to pass into the surrounding outer chamber 15 and then through the outlet 16. Like with cage-type globe valves, the present invention distributes the flow of fluid about its plug 17 through a series of multiple radial ports spaced about its cage 10. This dramatically reduces local flow velocities, helping to prevent cavitation, noise, vibration, wear, and loading on the plug as would normally be seen with single port valves. The present invention may be actuated rotatably, linearly, or a combination of the two using conventional means such as with manual, pneumatic, electric, solenoid, and hydraulic operators, as well as being flow actuated. The design variations possible with the present invention are as numerous as for cage-type globe valves to tackle an equal number of applications. Typically for a given cage-type globe valve design, the same engineering principles can be applied for the present invention, functioning in a much more efficient, compact and inexpensive design. One can look to existing art and apply it to the present invention. The radial porting of its cage can number two or more in any shape from round ports to triangular. They may be designed for quick opening, linear, equal percentage, or customized flow characteristics, as well as for cavitation control and noise attenuation. The cage may be single walled for controlling fluid flow in a single stage as it passes from within the cage to the outer chamber, or may have multiple ported walls so that fluid is controlled in multiple stages as it passes from within the cage, through the porting of the first wall, to the porting of the second wall etc. Multiple stage fluid conditioning is very often needed for controlling cavitation, erosion, or for noise attenuation. The plug also can be designed with either single or multiple walls, to interact with just one of the ported walls of the cage, or with multiple walls for controlling the flow of fluid. A popular way many cage-type globe valves control cavitation is by directing flow through the valve so that it travels radially from outside the O.D. of the cage to its I.D., impinging opposite streams of fluid at each other at the center of the cage to dissipate their energy. The present invention can also use this technique. Many cage-type globe valves control cavitation or noise by creating a tortuous or labyrinth path for the fluid to pass through once exiting its cage, to dissipate the fluid's energy in numerous gradual steps before exiting the valve. The present invention can also provide this feature by creating such a path within its outer chamber beginning at the radial ports of the cage. The cage can take on a variety of forms. It may be conical, spherical, parabolic, semi-circular, single or multiple walled, with tapered walls, flexible or rigid. It may be lined or coated with a secondary material such as elastomers, plastics, metals, ceramics etc. to provide increased sealing, durability, and reduction in cost. The valve's plug can take on any geometry to correspond to the cage for controlling the flow of fluid through it and may be actuated linearly, rotatably, or a combination of the two. The outer chamber 15 can also take on any suitable geometry to accomplish the task set forth by the designer. Referring to FIG. 10, the cage 10 can be offset to one side of the outer chamber 15 so that it is positioned towards the inlet side of the body. This offset increases the area on the opposite end of the outer chamber surrounding the radial porting 14 of the cage, allowing more room for pressure recovery and turbulence reduction of throttled fluids, as well as for the use of noise attenuation or anti-cavitation trim etc. The cage may be cast, molded, machined or welded as an integral part of the body, or may be threaded, bolted etc. to enable insertion and removal. If the cage is designed for removal, it needs to be provided with a sealing means with the body and may also incorporate tapered mating surfaces as will be described in the following method of using the cover to retain the cage within the body. Referring to FIGS. 11 & 12, the cage 10 may exist as a separate part from the body and may be retained in the body by the valve cover 20 as is typically done with cage-type globe valves. For this, the cage's inlet port 12 remains with the cage 10 and an additional inlet port 23 is created in the body, connected to its inlet 13. Both inlet ports 12 & 23 are provided with matching tapered surfaces 21 & 22 surrounding them designed to seal together when mated. A seal may be placed between the mating surfaces if needed. A first and second guide surface 24 & 25 on the inside of the cover 20 is designed to mate with the I.D. of the cage and of the body, (guide surface 24 with the cage and guide surface 25 with the body) while a guide surface 26 at the base of the body is designed to mate with the O.D. of the cage's base. As the cage is lowered into the guide surface 26 of the body as seen in FIG. 12, the tapered surfaces of the body 22 and cage 21 inlets mate. As the valve cover 20 is placed on the body, its first guide bushing 24 aligns the top of the cage with the cover while the second guide bushing 25 aligns the cover with the body. As the cover is tightened down, the cage is forced in a downward direction, tightening the tapers of the body and cage together and holding the cage firmly in place. To replace the cage the cover is simply opened and the cage removed. Referring to FIGS. 13-14, the present invention can be provided with a seat 27 along the I.D. of the cage surrounding its inlet port 12 made of PTFE, Graphite, Ceramic, elastomer, Metal etc. designed so that the plug 17 slidably seals against it like that of a plug and seal of a conventional plug valve. This allows the open/close sealing of the valve to take place here while the cage's radial porting 14 deals strictly with throttling. The plug is hollow and possesses an oblong inlet port 28 on one side which corresponds to that of the inlet port 12 of the cage , while its other side has its multiple ports 18 for throttling corresponding to those ports 14 of the cage. Referring to FIG. 15, when the valve of FIGS. 13 & 14 is in a closed position the surface of the outer diameter of the plug 29 seals against the seat 27 of the cage 10 at the cage's inlet port 12. The plug's inlet port 28 and radial porting 18 are at this point out of alignment with that of the cage's inlet port 12 and radial porting 14. Referring to FIG. 16, as the plug is rotated CCW the inlet port 28 of the plug aligns with the inlet port 12 of the cage, allowing fluid to enter the I.D. of the plug. At the same time, the plug's radial porting 18 is rotated along the I.D. of the cage 10, still in a closed position as they approach the cage's radial ports 14. The plug's inlet port 28 and radial porting 18 are positioned on the plug so that by the time the cage's inlet port 12 has fully opened, the cage's radial ports 14 are just beginning to open, throttling the flow through them as they do. Referring to FIG. 17, further rotation of the plug fully aligns its radial ports 18 with those of the cage's ports 14 to fully open flow through the valve. The cage's inlet port 12 is still maintained in a fully open position by the inlet port 28 of the plug. The radial ports of the plug can rotate back and forth across the radial ports of the cage to control the flow of fluid through them, while the inlet port of the cage remains in a fully open position. This design is good in that the seat 27 does not see any erosive wear from the throttling fluid. All of the dynamics of the throttled fluid flow are felt only by the radial porting. When the plug is rotated back to close the valve, the radial porting 18 of the plug first closes the radial porting 14 of the cage, and then the plug's inlet port 28 closes the inlet port 12 of the cage at its seat. Referring to FIG. 18, another option for the present invention is to provide an eccentric-type seat 30 at the cage's inlet port 12. The eccentric seat 30, like the sliding seat of the previous embodiment, completely surrounds the inlet port 12 of the cage. It protrudes inward from the cage's I.D. The outer surface of the plug 31 is designed to seal against the face of the seat 30 and is provided with a matching eccentric contour. The plug 17 has the same inlet port 28 and radial ports 18 as the previous embodiment, as are also the inlet port 12 and radial ports 14 of the cage. Referring to FIG. 19, when the plug is rotated CCW to open the valve, the eccentric seating surface 31 of the plug first breaks away from the eccentric seat 30 of the cage. The inlet port 28 of the plug then rotates into partial alignment with the inlet port 12 of the cage, allowing fluid to enter the I.D. of the cage. Continued rotation fully aligns the plug's inlet port 28 with the inlet port 12 of the cage. The plug and cage's radial porting 18 & 14 still remain in a closed position. Referring to FIG. 20, further rotation of the plug aligns its radial ports 18 with those of the cage 14 to fully open flow through the valve. The radial ports 18 of the plug can rotate back and forth across the radial ports 14 of the cage to control the flow of fluid through them, while the inlet port 12 of the cage remains in a fully open position. All of the dynamics of the throttled fluid flow are felt only by the radial porting. When the plug is rotated back to close the valve, the radial porting 14 of the cage closes first and then the cage's inlet port 12 at its seat 30. The sliding or eccentric seats of the present invention may be among other means integral, screwed in, bolted, welded, pressed, inlaid, or retained within the cage. The inlet, outlet, and all porting through the valve is defined as any flow passage which participates in the operation of the present invention as set forth in the scope of this application.

The present invention can be used as a check valve by providing an actuator which is energized by the fluid flowing through or past the valve. An actuator such as a vane, diaphragm, or piston type can be mounted either internally or externally to the body and is connected to the plug so that as fluid travels through the valve body in one direction, it pushes the actuator, moving the plug to an open position. Fluid flow in the opposite direction pushes the actuator to a closed position. For example, a rotary vane-type actuator and housing can be securely mounted within the body on top of the cage. The inlet of the actuator is connected to the inlet of the valve while the outlet end of the actuator is connected to the outlet of the valve. As fluid flows downstream through the valve piping with the valve in a closed position, the fluid pressure entering the inlet of the valve passes through to the inlet of the actuator, pushing the vane and causing the plug to rotate to an open position. The vane holds the plug in an open position so long as flow is maintained. Upon reverse flow, downstream fluid entering the outlet of the valve passes through to the outlet of the actuator, on the other side of the vane, pushing the vane back to its original position, causing the plug to rotate back to a closed position. The vane of the actuator is designed to contact and seal against the actuator's inlet so that reverse flow can not pass upstream when the vane has fully returned. A spring or other biasing means can be provided for the vane to assist in its return. This design is modified to function as a stop-check valve simply by providing additional actuation means operatively connected to the plug which when not engaged allows the vane to actuate the plug as a check valve as previously mentioned, but when engaged, is able to force the plug to a closed position. Automatic control of the valve such as for the pressure reduction of downstream fluid can be accomplished by using the vane actuator of the check valve mentioned earlier, with a biasing spring set to a specific resistance force so that as upstream fluid continuously pushes on the upstream side of the vane, and downstream fluid continuously pushes against the downstream side of the vane, the spring setting determines the degree the vane moves, which in turn determines the amount the plug is opened and the pressure ratio between the upstream and downstream fluid. The use of a spring or other biasing means to return the plug to a closed position enables the present invention to be used as a relief valve or automatic upstream pressure control valve. In these designs there is no downstream fluid exposed to the other side of the vane so that the upstream fluid pressure pushes strictly against spring force. The spring is set to a determined point which holds the plug in a closed position until the upstream pressure exceeds the force setting, causing the vane to rotate and the plug to rotate to varying degrees of an open position. The plug then rotates closed once the upstream pressure is relieved back to below the spring's set point. Those skilled m the art will realize how to adapt other actuation means for performing these same functions for the present invention as well as many other functions currently performed by globe valves.

Much of the present invention was designed after conventional rotary valves and cage type globe valves and uses typical valve practices and methods of manufacture, and may be designed to accommodate many of the options and accessories available in the valve industry including bellows seals, steam jacketing, encapsulation and coating of its surfaces with chemically resistant polymers, powder metal spraying, bypasses, water spray systems for steam conditioning, fluid mixing, filtering or metering devices, and may be used with various inline equipment. The valve can obviously be connected to an angle fitting to create and angle patterned valve.

The foregoing descriptions and illustrations have been given for clearness of understanding only and no unnecessary limitations should be understood therefrom as combinations and modifications of the above mentioned embodiments presented as well as many other suitable applications will be obvious to those skilled in the art or may be learned by practice of the invention as described within the accompanying claims.

What is claimed is:

1. A valve comprising:
a valve body comprising an inlet and outlet with a cage positioned between them, said cage having an inlet port means in communication with said inlet and multiple outlet port means in communication with said outlet, said inlet port means and multiple outlet port means radially positioned around said cage on a common axis of rotation; and
a plug moveably positioned about said cage so that its movement controls the simultaneous opening and closing of at least two of the cage's outlet port means, and the flow of fluid through the valve.

2. The valve of claim 1, wherein the cross-sectional flow path begins as circular at said inlet and transitions to an oblong cross-section to the cage's inlet port means.

3. The valve of claim 1, wherein the multiple outlet port means of the cage communicate with said outlet from an area common to said multiple outlet ports means.

4. The valve of claim 1, wherein the cage is cylindrical with its cylindrical axis essentially perpendicular to the flow of fluid through the valve.

5. The valve of claim 1, wherein the plug is positioned within the I.D. of said cage.

6. The valve of claim 1, wherein the inlet port means and multiple outlet port means of the cage are oblong.

7. The valve of claim 1, wherein the cage and plug have seating means corresponding to each other, designed to mate and seal.

8. The valve of claim 7, wherein the seating means is between the inlet port means of said cage and the plug.

9. The valve of claim 7, wherein the seating means are eccentric surfaces.

10. The valve of claim 1, wherein said plug's movement controls the simultaneous opening and closing of at least two of the cage's outlet port means, and the inlet port means, and the flow of fluid through the valve.

11. The valve of claim 1, wherein the plug's movement is rotary.

12. The valve of claim 1, wherein the plug has porting means which interacts with the porting means of the cage to control the flow of fluid through the valve.

13. The valve of claim 12, wherein the plug's porting means are oblong ports.

14. The valve of claim 12, wherein the plug's porting means comprises an inlet port and multiple radial outlet ports.

15. The valve of claim 1, wherein the plug is cylindrical.

16. The valve of claim 1, wherein the plug is hollow.

17. The valve of claim 10, wherein the plug opens said inlet port means before opening said multiple outlet port means.
